(19) United States
(12) Patent Application Publication
(10) Pub. No.: US 2013/0179869 A1
(43) Pub. Date: Jul. 11, 2013

(54) Adaptive Diversity for Compressible Return Oriented Programs

(71) Applicant: TELCORDIA TECHNOLOGIES, INC., Piscataway, NJ (US)

(72) Inventors: Michael W. Little, Hillsborough, NJ (US); Eric van den Berg, Hoboken, NJ (US)

(73) Assignee: TELCORDIA TECHNOLOGIES, INC., Piscataway, NJ (US)

(21) Appl. No.: 13/738,880

(22) Filed: Jan. 10, 2013

Related U.S. Application Data
(60) Provisional application No. 61/585,186, filed on Jan. 10, 2012.

(51) Int. Cl. G06F 9/45

(52) U.S. Cl. CPC G06F 8/40
USPC 717/136

(57) ABSTRACT

A method of transforming return oriented programming executables into functionally equivalent yet different forms with specific structural and/or functional characteristics that can assist in the use of such executables. A method automatically biases the structural and/or functional diversity of the return oriented programming software executables to achieve specific program representation objectives while preserving the programmatic capabilities of the original executable.

### CROSS-REFERENCE TO RELATED APPLICATIONS

This application claims the benefit of U.S. Provisional Application No. 61/585,186, filed on Jan. 10, 2012, which is incorporated by reference herein in its entirety.

### FIELD OF THE INVENTION

The present invention relates to a method for transforming return oriented programming executables into functionally equivalent yet different forms with specific structural and/or functional characteristics that can assist in the employment of such executables. Specifically, a method automatically biases the structural and/or functional diversity of return oriented programming software executable to achieve specific program representation objectives while preserving the programmatic capability of the original executable.

### BACKGROUND OF THE INVENTION

Return-oriented programming is a computer security exploit technique in which the attacker uses control of the call stack to indirectly execute cherry-picked machine instructions or groups of machine instructions immediately prior to the return instruction in subroutines within the existing program code, in a way similar to the execution of a threaded code interpreter.

Because all the instructions that are executed are from executable memory areas within the original program, this avoids the need for direct code injection, and circumvents most measures that try to prevent the execution of instructions from user-controlled memory.

Often the executed code itself consists only of 2 or 3 assembler instructions that can already perform a well-defined attack operation.

The representation of an executable program can have significant impact on its fitness for transmission, storage, execution, and/or recognition by security mechanisms. The current approach is to take the executable program as is and apply a rewriting mechanism, such as a compression algorithm, to achieve a more suitable (e.g. compact in the case of compression) representation for storage and/or transmission. One motivation for the present invention is whether one could not rewrite the compiled program into a different yet functionally equivalent program that would be better to compress (e.g. result in a more compact version) than the original program.

The inventors have devised a method to automatically bias the structural and/or functional diversity of return-oriented programming software executables to achieve specific program representation objectives while preserving the programmatic capability of the original executable. Executables having specific structural and/or functional characteristics not otherwise present (or having sufficient presence) in the original that can achieve ulterior objectives not otherwise obtainable by employing the original executable. For example, varying the entropy of a program representation varies the ease (or difficulty) of compressing that representation. Because our method relies on return oriented programming the executables themselves are not easily recognized as such, and the application of this biasing methodology can enable such executable forms to be applied or utilized in circumstances where traditional executables (return oriented programming or not) cannot.

Two domains are particularly relevant to this problem—information theory and program translation. It is known in information theory that the measure of the number of extra bits required to code an information instance from symbolic domain P using symbols from domain Q is the relative entropy, or Kullback-Leiber divergence as described in the article Kullback, S.; Leibler, R. A. (1951). “On Information and Sufficiency”. Annals of Mathematical Statistics 22 (1): 79-86. If the distributions are in alignment, then extra bits are not required for the coding. This is a viable approach to the present problem when one is allowed to choose at least one of the two domains. As a relative example, in data compression, one generally does not get to choose the distribution of the input (also known as the target) domain. The output domain itself is dependent upon the compression scheme utilized. As such, practical data compression applications attempt to minimize the relative difference between the coded representation and the target representation. In our problem space, much like the data compression problem space, there is no choice with regard to the initial input, or target, domain as the target is an executable program. Specifically, we are interested in lossless schemes as the integrity of the program executable is to be maintained. Notably different, however, from data compression, is that the problem being solved by the invention further assumes the rewriting scheme (and its associated symbol domain) is to be known but fixed a priori. Thus, adapting the output domain to the input is not an option.

In program translation the objective is to rewrite the input form (e.g. source code) into a distinct output form (e.g. binary executable). Essentially, altering the input form such that functional integrity is maintained while altering the structural form. Two broad aspects of program translation are of particular interest: compilation and automated diversity.

Program compilers have been constructed to vary the efficiency of the resulting representation generally for the purpose of (1) expected speed of execution, (2) expected runtime storage requirements, and/or (3) expected load time storage requirements. Compiler technology that is concerned with producing a program representation for subsequent rewriting is primarily concerned with intermediate forms that will be either (a) recompiled (e.g. precompilers), or (b) translated on-the-fly for execution (e.g. script compilers and just-in-time compilers). Further, compilers are not constructed to re-interpret their result (the executable code) so as to produce a acceptable output result, but instead are re-launched, often with new options, and begin again from the original source code. Just-in-time compilers, such as made for the Java run-time language, use the run-time language as their source code form and output a machine instruction form. They do not rewrite the executable to maintain its same form. Just-in-time compilers are described, for instance, in Aycock, J. (June 2003). “A brief history of just-in-time”. ACM Computing Surveys 35 (2): 97-113.

Automated diversity (polymorphism and metamorphism) of executables has been created before by directly rewriting (functionally equivalent) assembly code. Furthermore, Return Oriented Programming has been used before. See, e.g., R. Roemer, E. Buchanan, H. Shacham and S. Savage, “Return-Oriented Programming: Systems, Languages, and Applications”, In review, October 2009, R. Hund, T. Holz, F. C. Freiling, “Return-Oriented Rootkits: Bypassing Kernel Code Integrity Protection Mechanisms”, Proceedings USENIX Security 2009, August 2009, and S. Checkoway, A. Feldman, B. Kantor, J. A. Halderman, E. W. Felten and H. Shacham, “Can DREs Provide Long-Lasting Security? The Case of Return-Oriented Programming and the AVC Advantage”, Proceedings EVT/WOTE 2009, August 2009.

Return Oriented Programming has not been used for creating automated diversity. A pending patent application by the inventors of the present application, U.S. patent application Ser. No. 13/014,788 entitled “Automated Diversity Using Return Oriented Programming” (hereafter referred to as the “'788 application”), which is incorporated herein by reference in its entirety, describes an approach towards achieving executable diversity without relying on injecting and/or sending actual (rewritten) assembly code that results in return oriented programming executables. Yet this approach is limited in that it only creates functionally equivalent yet distinctly different executables. It does not provide a means to adapt or control either the structural or functional form of the result, nor bias the result to meet a specific objective.

One prior approach to this problem is the process of program compilation. Unfortunately, compilers translate from one representational form to another. While they create functionally equivalent yet distinctly different representations, they do not maintain the original representational form.

Another relevant prior approach is that of compression. Compression algorithms in general take a given input representation and rewrite this representation (compresses it) such that it can subsequently be rewritten (uncompressed) into an identical (lossless compression) or similar (lossy compression) form. Only lossless approaches are relevant to the problem at hand. The compressed form is constructed simply to minimize size of representation and is structured solely for the uncompression algorithm. The representational form cannot be used as-is and must be processed again (e.g. decompressed) prior to use.

The ROP mapper in the '788 application is focused on creating an executable representation, without specific regard for the communication compressibility or other characteristic of the output form with regard to rewriting of the output form.

The present invention relates to directing the ROP mapper to create an alternative executable representation within the same representational domain which at the same time is a good input representation for a specific executable consumer such as a compressor. The ROP mapper creates an intermediate representation which is in fact still executable.

This first step bears resemblance to program encryption. However, compression does not yield benefits on typical encryption output, since these are designed to have maximum entropy, making them almost incompressible. In the present case, we can vary the entropy of the intermediate representation, while maintaining the representation of an executable program.

Automated diversity of Return Oriented Programs executables has been created before by directly rewriting (functionally equivalent) assembly code. It is still possible to recognize it as an executable and to create a signature for it, for example using fast disassembly as in Hund et al, supra. The novelty of the current invention is that the automated diversity does not rely on injecting and/or sending actual (or rewritten) assembly code making existing recognition techniques (e.g. Hund et al) ineffective.

### SUMMARY OF THE INVENTION

In the present invention we allow the input stream to be selectively re-written. Further, the re-writing of the input stream is in a symbolic domain where there are many unique symbolic representations with identical semantics. Typically, there is a one-to-one correspondence between semantics and representation resulting in a single symbol per concept, as found in contemporary executable representations (e.g. instruction sets). In return-oriented program representations, the gadgets may differ in structural representation (e.g., have different addresses) yet reference identical instruction sequences. For example, the instruction sequence, or gadget, [PUSH, INC, RET] may be found at fifteen distinct starting address locations, thereby having fifteen unique symbolic representations for the same functional semantic. Further, sequences of symbols (e.g. gadgets) may be functionally equivalent yet structurally different in that the underlying sequence of instructions may be identical while the gadgets themselves are unique. The three gadgets [LOAD, RET], [PUSH, RET], and [INC, RET] are functionally equivalent to the gadget [LOAD, PUSH, INC, RET]. Thus, a sequence of three symbols is semantically equivalent to a single symbol. Either can be utilized. An additional point of novelty of the present invention is that this semantic equivalence of distinct symbols is leveraged to enrich the potential target domain in three ways: the size of the alphabet, symbol fitness, and the relationship between symbols in the alphabet. Size is strictly the number of distinct symbols (e.g. gadget addresses) but can be further considered as the number of all equivalent symbols (the number of distinct equivalent choices) and the number of non-equivalent symbols. One example of symbol relationship that we can establish is “distance”, measured as the difference between two gadget addresses. Another relationship between symbols that can be established is similarity, defined as the number of similar (or dissimilar) bits. The fitness of a symbol is measured by a pass/fail function. Symbols that pass are included in the potential target domain while all others are excluded. As an example fitness function is one that limits the address range that symbols may span. Symbol set size, relationships, and fitness functions of interest are strongly dependent upon the entropy model.

The ability to vary the input symbol set underlies another novel aspect of the invention, that of applying selection bias. Our invention employs two aspects of selection bias—that of biasing the selection of symbols for inclusion in the potential target domain (domain biasing), and that of selecting symbols from the potential target domain for the candidate representation (representation biasing). Domain biasing operates to constrain the domain from which we can produce candidate representations. For example, we can favor gadgets that have location density. We can also work to limit the number of unique gadgets.

An additional point of novelty is that we leverage this semantic equivalence of distinct symbols to enrich the symbolic domain from which we selectively choose to create a candidate result. Such enrichment of the symbolic domain enables greater diversity of candidate output sets than can be achieved through more traditional approaches.

Another point of novelty is that we can selectively insert functionally agnostic gadgets to help achieve a desired density or relationship property (e.g. to create a familiar or recurrent sequence) within the output set.

We have devised a method to automatically bias the structural and/or functional diversity of return-oriented programming software executables to achieve specific program representation objectives while preserving the programmatic capability of the original executable. For example, varying the entropy of a program representation varies the ease (or difficulty) of compressing that representation. Our method relies on return oriented programming wherein the executables themselves are not easily recognized as such, and the application of this biasing methodology can enable such executable forms to be applied or utilized in circumstances where traditional executables (return oriented programming or not) cannot.

One specific novelty of this approach is that the ROP mapper creates an intermediate representation which is in fact still executable.

This first step bears resemblance to program encryption. However, compression does not yield benefits on typical encryption output, since these are designed to have maximum entropy, making them almost incompressible. In the present invention, it is possible to vary the entropy of the intermediate representation, while maintaining the representation of an executable program.

The novelty of this approach is that we allow the input stream to be selectively re-written to influence the compressible stream. In effect, we get to choose the most optimal input to meet the objective.

One novelty of this approach is that we have the ability to alter the input stream for compression consideration prior to compression occurring. In effect, we get to choose from a number of possible input streams the one that we would prefer.

Manipulating the input to improve compression is a common approach in methods of recasting programs into new instruction domains.

Executable forms of software programs are created to match a specific target runtime environment (be that a hardware-based or a software-based interpreter). These executable forms consist of instructions that the runtime environment (or machine) interprets. The emphasis of creating these executable forms has been primarily on assisting performance characteristics of execution and generally along the lines of space (memory consumed either for representation and/or execution) and time (number of actions completed in a given timeframe). Historical and contemporary instruction set representations can be characterized as having a single unique representation for each instruction performed. This is often to minimize the number of bits needed to represent the full instruction set. A novel characteristic of return-oriented program (ROP) representation is the fact that any given instruction—or gadget in ROP parlance—can have a multiplicity of representations. This is an unconventional view of instruction sets. Additionally, in translating a traditional executable form to a ROP domain the mapping from traditional instructions to gadgets is not one-to-one but many-to-many. Therefore, the choice of gadgets to employ also influences the number of unique representational forms that can be considered. It is also an uncommon view in the domain of compression algorithms to consider the input form to be anything other than a fixed representation of the information to compress.

Our solution of adaptive program diversity creates a method for biasing program representation to achieve specific influences on subsequent consumers of the program representation—notably on compression algorithms and the target run-time environment. This can increase (or decrease) transmission (and/or storage) compression efficiency. This can also increase (or decrease) the locality of referencing in a run-time environment. The degree of influence exerted is controllable.

The invention provides the means to rewrite an executable data input stream for a compression algorithm (or other consumer) so as to maintain the executable integrity of the original program while improving the fitness of the input stream for the consumer. When the consumer is a compression algorithm, the invention can directly impact (positive or negative) the performance of the algorithm. A positive influence example would be to reduce the number of symbols in the input stream. A 25% reduction in the number of symbols utilized can result in a similar, or greater, result in the output from the compression algorithm. As return oriented programs consist primarily of address references, selecting addresses that are close to one another can also positively impact the compression algorithm performance resulting in a significantly smaller representation than would otherwise be achieved.

Interestingly, the invention also allows for the deterioration of consumer (e.g. compression) algorithm performance. If one wished to elevate the burden on the compression algorithm, the invention allows for dramatic expansion of the number of symbols utilized and they can be chosen to specifically mismatch with their neighbors with regards to the targeted compression algorithm. In this way, the output of the compression algorithm would be significantly larger than if our invention was not applied to the compression algorithm input data stream.

In another application, the invention can condition the return oriented program so as to minimize, or maximize, the locality of references made by the program when run on a target machine. The locality of referencing can influence the ability of security software to detect the running program.

Another possible conditioning would be to randomize the selection of otherwise equivalent symbols in the output stream. When used in this fashion, the invention would produce randomized versions of the input. Such randomization provides support for the concept of a moving target defense.

The invention will be better understood when the following description is read in conjunction with the accompanying drawings.

### BRIEF DESCRIPTION OF THE DRAWINGS

FIG. 1 is a flow diagram of a method of practicing an application of the present invention.

### DETAILED DESCRIPTION

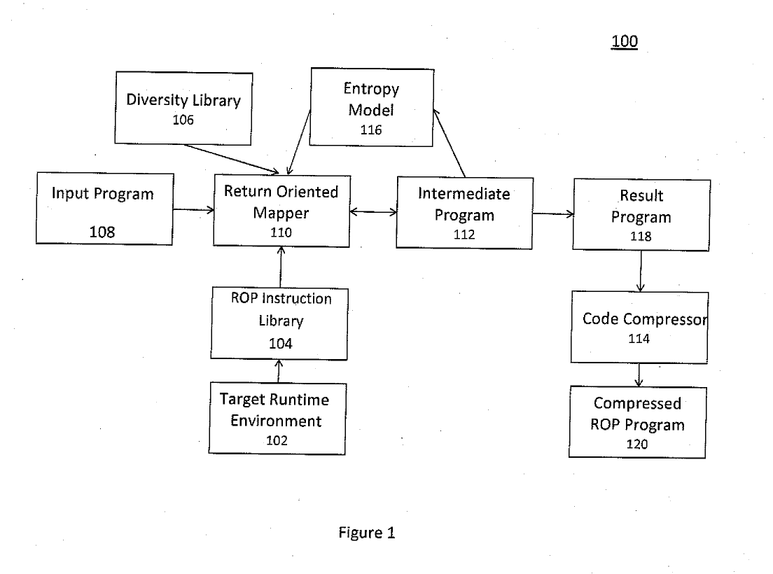

Referring to FIG. 1, there is shown a flow diagram of a method of practicing the present invention 100. Given a target runtime environment 102, first create a return oriented program instruction library 104 as a large collection of code fragments which end in a ‘return’ instruction from the target runtime environment. These code fragments are one or more instructions in length and are arranged efficiently in a trie data structure starting from each found ‘return’ instruction. The trie is filled by considering each valid ‘return’ ended fragment as a postfix for other possible valid instructions. Further valid instructions are found by working backwards from the first return ended instruction; (See, e.g., Kullback et al). Continue the search process on different pieces of code inside the target runtime environment, until sufficiently many (including redundant) instruction sequences have been found. Each node in the trie is annotated with descriptive information regarding the code fragment and the context in which it occurs. One instantiation of such descriptive information is the library name, instruction encoding, and relative address of the instruction.

While the return oriented program instruction library may provide for a multiplicity of choice in code fragments, this diversity can be further enhanced by the inclusion of a diversity library 106. The diversity library supports the ability to diversify the input program 108 and/or the output program of the return oriented mapper 110, intermediate program 112. We call the former input diversity and the latter output diversity. Input diversity is achieved by modifying the input program 108 to a different yet functionally equivalent form (i.e. inserting NOP's and/or functionally ineffective instructions). Output diversity is achieved by inserting non-functional return oriented program components (i.e. non-functional ROP sequences). Input diversity expands the potential code fragment choices available in the ROP library, while output diversity provides additional code fragment choice at most any point in the mapping process, effectively expanding the currently applicable ROP library content.

Given a code compressor 114, establish an entropy model 116 representing the information encoding capabilities of the code compressor. Such a model represents the contextual probability of the resultant encoding. See, e.g., Aycock, Roemer et al, and Hund et al. This model is interpreted by the return oriented instruction mapper 110 to guide the mapping operation whenever multiple mapping outcomes exist. The choice of outcome to be selected is determined by the mapper which considers the relative degree to which a particular outcome may inhibit or support the entropy model. For an entropy model constructed as a probability distribution function, the mapper may determine the probability distribution for each choice and select the outcome with the highest (or lowest) probability. This purposeful alignment, or misalignment, of the mapping of the input program 108 into a result program 118 is intended to facilitate, or inconvenience, the compressor 114 and/or minimize, or maximize, the encoding of the resultant compressed return oriented program 120. Note that the entropy model could be a purely random model and/or the mapper selection process could be a random function, and when so constructed could produce, when successively requested to process the same input program, a multiplicity of functionally equivalent yet uniquely encoded output instances. Further note that the compressor element of the invention can be any code transformative process or code examining decision process that may be represented with an entropy model.

When the mapper produces an intermediate program 112, this intermediate program can be used as context by both the entropy model and the mapper. The intermediate program is not necessarily a complete mapping of the input program as it may also be a transitional and/or incomplete mapping. The entropy model can utilize the intermediate program to refine its determination of the expected outcome of the compressor process. The mapper can use the intermediate program as a guide towards producing an improved final outcome. For example, the intermediate program can aid the mapper in identifying regions requiring improvement, and in backtracking while searching for alternative improved mappings.

Once the intermediate program is a complete representation of the input program, the mapper performs a quality test on the program. The quality test ensures an acceptable match to the entropy model. If the quality test is successful, the intermediate program 112 is promoted to be the result program 118. If the quality test is not successful, the mapper may optionally perform a subsequent attempt. Any subsequent attempt can take into account the results of prior attempts, including those mapping decisions made that resulted in prior outcomes. Generally, the acceptance criteria considered by the mapper would be a function that compares the intermediate program to the entropy model. The function may have either a binary outcome (acceptable or not acceptable) or result in a continuous measure to be compared against a threshold value to determine acceptability. For instance, the success criteria can vary from always acceptable to only acceptable if a perfect match or somewhere in between. The quality test may also take the best result of a deterministic number of attempts, as it is likely that a perfect, or near perfect, alignment with the entropy model may be difficult to achieve and that the mapper process would need to be terminated on effort expended rather than result achieved. We note that employing this invention to achieve a multiplicity of random variants of the input program would likely employ a quality test that accepts all outcomes (or all non-duplicate outcomes for a given sequence of attempts).

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions stored in a computer or machine usable or readable storage medium or device, which causes the computer or machine to perform the steps of the method when executed on the computer, processor, and/or machine. A computer readable storage medium or device may include any tangible device that can store a computer code or instruction that can be read and executed by a computer or a machine. Examples of computer readable storage medium or device may include, but are not limited to, hard disk, diskette, memory devices such as random access memory (RAM), read-only memory (ROM), optical storage device, and other recording or storage media.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

While there has been described and illustrated a method of transforming return oriented programming executables into functionally equivalent forms, it will be apparent to those skilled in the art that variations and modifications are possible without deviating from the broad principles of the present invention which shall be limited solely by the scope of the claims appended hereto.

What is claimed is:

1. A method of transforming return oriented programming executables into functionally equivalent forms comprising:
providing a target runtime environment;
creating a return oriented program instruction library comprising a collection of code fragments which end in a ‘return’ instruction from the target runtime environment;
searching different code fragments in the target runtime environment until a predetermined quantity of instruction sequences are found;
diversifying an input program and/or an output of a return oriented mapper to provide an intermediate program or a result program;
mapping the input program by the mapper resulting in an intermediate program or a result program encoded for a consumer; and
establishing an entropy model representing the consumer usage of the result program to be interpreted by the mapper to guide mapping.

2. The method of claim 1 further comprising performing a quality test on the intermediate program.

3. The method of claim 2, where if the quality test is successful, the intermediate program becomes the result program.

4. The method of claim 2, where if the quality test is unsuccessful, performing subsequent quality tests taking into account the results of the prior quality test.

5. The method of claim 1, whereby the entropy model is a random model.

6. The method of claim 1, whereby the mapper is a random function.

7. The method of claim 1, whereby the intermediate program is used as a context by the entropy model.

8. The method of claim 1, whereby the intermediate program is used as a context by the mapper.

9. The method of claim 1, whereby diversifying an input program provides a different yet functionally equivalent form.

10. The method of claim 1, whereby diversifying an output of the mapper comprises inserting non-functional return oriented program components.

11. The method of claim 1, whereby the output of the mapper is influenced by the extent to which the intermediate program inhibits or supports the entropy model.

12. The method of claim 1, whereby the return oriented program instruction library is augmented with information regarding the context of the instruction from the target runtime environment.

13. The method of claim 1, whereby the return oriented program instruction library is augmented with information regarding the possible equivalence and/or comparability between a plurality return oriented program instruction sequences and/or their runtime context.

14. The method of claim 1, whereby the mapper is augmented with information regarding the possible equivalence and/or comparability between a plurality of return oriented program instruction sequences and/or their runtime context.

15. The method of claim 1, whereby the diversity library is augmented with information regarding the possible equivalence and/or comparability between a plurality of return oriented program instruction sequences and/or their runtime context.

16. The method of claim 1 further comprising applying the intermediate program to a code compressor; wherein the entropy model represents the information encoding capabilities of the code compressor resulting in an intermediate program or a result program encoded for creating a compressed result oriented program.

17. A computer readable storage device storing a program of instructions executable by a machine to perform a method for transforming return oriented programming executables into functionally equivalent forms, comprising:
providing a target runtime environment;
creating a return oriented program instruction library comprising a collection of code fragments which end in a ‘return’ instruction from the target runtime environment;
searching different code fragments in the target runtime environment until a predetermined quantity of instruction sequences are found;
diversifying an input program and/or an output of a return oriented mapper to provide an intermediate program or a result program;
mapping the input program by the mapper resulting in an intermediate program or a result program encoded for a consumer; and
establishing an entropy model representing the consumer usage of the result program to be interpreted by the mapper to guide mapping.

18. The computer readable storage device as set forth in claim 17, the program further comprising performing a quality test on the intermediate program.

19. The computer readable storage device as set forth in claim 18, wherein if the quality test is successful, the intermediate program becomes the result program.

20. The computer readable storage device as set forth in claim 18, wherein if the quality test is unsuccessful, performing subsequent quality tests taking into account the results of the prior quality test.

21. The computer readable storage device as set forth in claim 17, whereby the entropy model is a random model.

22. The computer readable storage device as set forth in claim 17, whereby the mapper is a random function.

23. The computer readable storage device as set forth in claim 17, whereby diversifying an input program provides a different yet functionally equivalently form.

24. The computer readable storage device as set forth in claim 17, whereby diversifying an output of the mapper comprises inserting non-functional return oriented program components.

25. The computer readable storage device as set forth in claim 17, whereby the output of the mapper is d by the mapper considering the relative degree to which outcomes inhibits or supports the entropy model.

26. The computer readable storage device as set forth in claim 17, the program further comprising applying the intermediate program to a code compressor; wherein the entropy model represents the information encoding capabilities of the code compressor resulting in an intermediate program or a result program encoded for creating a compressed result oriented program.

27. The computer readable storage device as set forth in claim 17, the program further augmenting the return oriented program instruction library with information regarding the context of the instruction from the target runtime environment.

28. The computer readable storage medium as set forth in claim 17, the program further augmenting the return oriented program instruction library with information regarding the possible equivalence and/or comparability between a plurality of return oriented program instruction sequences and/or their runtime context.

29. The computer readable storage medium as set forth in claim 17, the program further augmenting the mapper with information regarding the possible equivalence and/or comparability between a plurality of return oriented program instruction sequences and/or their runtime context.

30. The computer readable storage medium as set forth in claim 17, the program further augmenting the diversity library with information regarding the possible equivalence and/or comparability between a plurality of return oriented program instruction sequences and/or their runtime context.

31. The computer readable storage medium as set forth in claim 17, the program further using the intermediate program as a context by the entropy model.

32. The computer readable storage medium as set forth in claim 17, the program using the intermediate program as a context by the mapper.
